(19) United States
(12) Patent Application Publication
(10) Pub. No.: US 2025/0386134 A1
(43) Pub. Date: Dec. 18, 2025

(54) Speaker Module, Speaker System, and Vehicle

(71) Applicant: Shenzhen Yinwang Intelligent Technologies Co., Ltd., Shenzhen (CN)

(72) Inventors: Wenguang Chen, Dongguan (CN); Chengrong Ma, Dongguan (CN); Zhangzhao Yang, Dongguan (CN)

(73) Assignee: Shenzhen Yinwang Intelligent Technologies Co., Ltd., Shenzhen (CN)

(21) Appl. No.: 19/267,003

(22) Filed: Jul. 11, 2025

Related U.S. Application Data
(63) Continuation of application No. PCT/CN2024/071207, filed on Jan. 8, 2024.

(30) Foreign Application Priority Data
Jan. 12, 2023 (CN) 202310072591.2

(51) Int. Cl. H04R 1/28; H04R 1/02; H04R 9/02; H04R 9/04; H04R 9/06

(52) U.S. Cl. CPC H04R 1/2834; H04R 1/025; H04R 9/025; H04R 9/043; H04R 9/06; H04R 2400/11; H04R 2499/13

(57) ABSTRACT

A speaker module includes a frame body, a speaker, and a passive vibration plate. A resonant frequency of the passive vibration plate is greater than a resonant frequency of the speaker. Both the speaker and the passive vibration plate are installed on the frame body, and a cavity is formed among the frame body, the speaker, and the passive vibration plate. The frame body is provided with a vent, and the vent communicates with the cavity.

### CROSS-REFERENCE TO RELATED APPLICATIONS

This is a continuation of International Patent Application No. PCT/CN2024/071207 filed on Jan. 8, 2024, which claims priority to Chinese Patent Application No. 202310072591.2 filed on Jan. 12, 2023. The disclosures of the aforementioned applications are hereby incorporated by reference in their entireties.

### TECHNICAL FIELD

The present disclosure relates to the field of acoustic device technologies, and in particular, to a speaker module, a speaker system, and a vehicle.

### BACKGROUND

A speaker is an electroacoustic transducer that converts electric energy into sound energy and radiates the sound energy to a distant place.

For the speaker, how to improve a low-frequency extension capability of the speaker and increase a sound pressure level of the speaker on an operating frequency band is a key technical issue.

### SUMMARY

The present disclosure provides a speaker module, a speaker system, and a vehicle. The speaker module includes a frame body, a speaker, and a passive vibration plate, and a resonant frequency of the passive vibration plate is greater than a resonant frequency of the speaker. The frame body is provided with a vent, and the vent communicates with a cavity among the frame body, the speaker, and the passive vibration plate. The vent communicates with a rear cavity that is large enough, so that a low-frequency extension capability of the speaker module can be improved. In addition, sound waves radiated outward by the speaker and the passive vibration plate through vibration can be superposed, thereby increasing a sound pressure level of the speaker module. Technical solutions of the speaker module, the speaker system, and the vehicle are as follows.

According to a first aspect, the present disclosure provides a speaker module. The speaker module includes a frame body, a speaker, and a passive vibration plate, and a resonant frequency of the passive vibration plate is greater than a resonant frequency of the speaker. The frame body is provided with a first opening, a second opening, and a vent. The speaker is located at the first opening, the passive vibration plate is located at the second opening, a cavity is formed among the frame body, the speaker, and the passive vibration plate, and the cavity communicates with the vent.

The frame body is configured to support the speaker and the passive vibration plate, and can protect the speaker and the passive vibration plate to some extent. The frame body is provided with the vent, and the vent may communicate with a rear cavity. A larger volume of the rear cavity indicates smaller resistance generated by air in the rear cavity and the frame body to vibration of the speaker and the passive vibration plate, and smaller improvement effect on the resonant frequency of the speaker. Because a lower limit frequency of an operating frequency band of the speaker is near the resonant frequency of the speaker, a larger volume of the rear cavity communicating with the vent indicates a stronger low-frequency extension capability of the speaker module.

The speaker includes a vibration assembly, the vibration assembly includes a vibration plate, and the vibration plate generates a sound when vibrating. The cavity may be located among the frame body, the vibration plate, and the passive vibration plate. The vibration plate may also be referred to as a vibration membrane, a diaphragm, a vibration disk, or the like.

The passive vibration plate is similar to the vibration plate, but does not need to be driven by an electrical signal during operation, and a sound is generated through vibration based on fluid-solid coupling. When the vibration plate in the speaker vibrates, the passive vibration plate can vibrate under driving of the vibration plate. The passive vibration plate may also be referred to as a passive vibration membrane, a passive diaphragm, a passive radiator (PR), a PR disk, or the like.

According to the technical solution provided in the present disclosure, the frame body of the speaker module is provided with the vent, and the vent communicates with the cavity. In this case, a low-frequency extension capability of the speaker module can be improved by making the vent communicate with the rear cavity with a volume that is large enough, to ensure low-frequency performance of the speaker module.

In addition, the passive vibration plate is disposed in the speaker module provided in the present disclosure, and the passive vibration plate can vibrate under driving of the speaker, so that the passive vibration plate is used as a secondary sound source to radiate a sound wave to the outside of the frame body. In addition, the resonant frequency of the passive vibration plate is set to be greater than the resonant frequency of the speaker, so that within an operating frequency band of the speaker module, sound waves radiated outward by the passive vibration plate and the speaker can be superposed. This increases a sound pressure level of the speaker module on the operating frequency band, and improves sound energy utilization.

In a possible implementation, a ratio of the resonant frequency of the passive vibration plate to an upper limit frequency of the operating frequency band of the speaker module is greater than 0.8.

When the speaker module operates on a frequency band greater than the resonant frequency of the speaker and less than the resonant frequency of the passive vibration plate, a sound wave radiated outward by the speaker and a sound wave radiated outward by the passive vibration plate are superposed. When the speaker module operates on a frequency band greater than the resonant frequency of the passive vibration plate, a sound wave radiated outward by the speaker and a sound wave radiated outward by the passive vibration plate cancel each other out. Therefore, the upper limit frequency of the operating frequency band of the speaker module depends on the resonant frequency of the passive vibration plate to some extent.

The ratio of the resonant frequency of the passive vibration plate to the upper limit frequency of the operating frequency band of the speaker module is set to be greater than 0.8, so that within most of the operating frequency band of the speaker module, sound waves radiated outward by the speaker and the passive vibration plate are superposed. This increases the sound pressure level of the speaker module on the operating frequency band.

In a possible implementation, the ratio of the resonant frequency of the passive vibration plate to the upper limit frequency of the operating frequency band of the speaker module is greater than or equal to 1.

In this way, it can be ensured that within the entire operating frequency band of the speaker module, sound waves radiated outward by the speaker and the passive vibration plate are superposed.

In a possible implementation, the ratio of the resonant frequency of the passive vibration plate to the upper limit frequency of the operating frequency band of the speaker module is less than 2.

Because the passive vibration plate has greatest amplitude at the resonant frequency, the resonant frequency of the passive vibration plate shall not exceed the upper limit frequency of the operating frequency band of the speaker module by too much for utilization of a sound wave generated by the passive vibration plate near the resonant frequency.

In a possible implementation, the ratio of the resonant frequency of the passive vibration plate to the upper limit frequency of the operating frequency band of the speaker module is less than 1.5.

In a possible implementation, the ratio of the resonant frequency of the passive vibration plate to the upper limit frequency of the operating frequency band of the speaker module is less than 1.2.

In a possible implementation, the resonant frequency of the passive vibration plate is greater than a first frequency, and the first frequency is a resonant frequency of a system including the cavity and the passive vibration plate.

When the speaker module operates at the first frequency, because the system including the cavity and the passive vibration plate generates resonance, great mechanical impedance is generated to the speaker. Consequently, a sound wave radiated by the speaker at the first frequency is a minimum.

The resonant frequency of the passive vibration plate is set to be greater than the first frequency, so that a sound wave radiated by the speaker and a sound wave radiated by the passive vibration plate are in a same phase when the speaker module operates at the first frequency. In this case, under superposition effect of a sound wave radiated outward by the passive vibration plate, a sound pressure level of a sound wave radiated by the speaker module at the first frequency is still high.

In a possible implementation, a ratio of the resonant frequency of the passive vibration plate to the resonant frequency of the speaker is greater than 1.5.

In a possible implementation, the ratio of the resonant frequency of the passive vibration plate to the resonant frequency of the speaker is greater than 2.

In a possible implementation, a ratio of mass of the passive vibration plate to mass of a vibration assembly of the speaker is less than 0.5. In this way, the resonant frequency of the passive vibration plate and the resonant frequency of the speaker can satisfy the foregoing relationship.

In a possible implementation, the ratio of the mass of the passive vibration plate to the mass of the vibration assembly is less than 0.2.

In a possible implementation, a ratio of an area of the passive vibration plate to an area of a vibration plate of the speaker is greater than 0.5 and less than 2.

In this way, superposition effect of sound waves generated by the passive vibration plate and the speaker is better, so that the sound pressure level of the speaker module is higher.

In a possible implementation, the vent is configured to communicate with the rear cavity, and a ratio of a volume of the rear cavity to a volume of the cavity is greater than 10.

In a possible implementation, the rear cavity is an infinitely large rear cavity.

In a possible implementation, the speaker module is used in the inside of a vehicle, and the rear cavity is space outside the vehicle.

In a possible implementation, the speaker module is used in the inside of a room, and the rear cavity is space outside the room or space inside another room.

In a possible implementation, the frame body is provided with a pipe, the pipe communicates with the cavity, and the pipe is provided with the vent. The presence of the pipe can also increase the sound pressure level of the speaker module.

In a possible implementation, the frame body includes a main portion and a pipe, the main portion is provided with the first opening and the second opening, and the cavity is formed among the main portion, the speaker, and the passive vibration plate. One end of the pipe communicates with the cavity, and the other end of the pipe is provided with the vent.

In a possible implementation, a ratio of a resonant frequency of the cavity and the pipe to the resonant frequency of the passive vibration plate is greater than 0.5.

In a possible implementation, the ratio of the resonant frequency of the cavity and the pipe to the resonant frequency of the passive vibration plate is greater than 0.7.

In a possible implementation, the ratio of the resonant frequency of the cavity and the pipe to the resonant frequency of the passive vibration plate is less than 5.

In a possible implementation, the ratio of the resonant frequency of the cavity and the pipe to the resonant frequency of the passive vibration plate is less than 3.

In a possible implementation, the first opening and the second opening are located at two ends of the main portion respectively, and the pipe is connected to a side of the main portion.

In a possible implementation, the speaker closes the first opening, and the passive vibration plate closes the second opening.

In a possible implementation, the speaker is opposite to the passive vibration plate. In this way, space occupied by the speaker and the passive vibration plate can be reduced, which helps reduce a volume of the speaker module.

In a possible implementation, there are two first openings, and the two first openings are opposite to each other. The speaker includes a first speaker and a second speaker, the first speaker and the second speaker are located at the two first openings respectively, and the first speaker abuts against the second speaker. Vibration directions of vibration plates in the two speakers are opposite. In other words, the two vibration plates either move toward each other or move away from each other. In this case, reaction forces caused by vibration of the vibration plates cancel each other out, and vibration of support assemblies of the two speakers is small. This helps decrease resonant amplitude of the speaker module, and can improve sound quality.

In a possible implementation, there are two second openings, the passive vibration plate includes a first passive vibration plate and a second passive vibration plate, and the first passive vibration plate and the second passive vibration plate are located at the two second openings respectively. One cavity is formed among the first speaker, the first passive vibration plate, and the frame body, one cavity is formed among the second speaker, the second passive vibration plate, and the frame body, and each of the two cavities communicates with the vent.

In a possible implementation, the speaker module further includes a protective cover, and the protective cover is connected to the frame body and covers the passive vibration plate. The protective cover can protect the passive vibration plate, to reduce a possibility that the passive vibration plate is damaged.

In addition, the protective cover includes a frame structure. Therefore, the protective cover does not seal an outer side of the passive vibration plate, and the protective cover does not affect vibration of the passive vibration plate.

In a possible implementation, the speaker includes a support assembly, a magnetic circuit assembly, and the vibration assembly, and the vibration assembly includes a voice coil, the vibration plate, and a centering spider. The support assembly supports the magnetic circuit assembly and the vibration assembly. The magnetic circuit assembly is configured to drive the voice coil to vibrate. The vibration plate is connected to the voice coil and the support assembly. The centering spider is connected to the vibration plate and the support assembly.

The centering spider may also be referred to as a damper.

In a possible implementation, the centering spider is in a ring shape, an inner side of the centering spider is connected to the vibration plate, and an outer side of the centering spider is connected to the support assembly.

In a possible implementation, there is a frame structure on a side that is of the support assembly and that faces the cavity.

According to a second aspect, the present disclosure provides a speaker system. The speaker system includes a wall and the speaker module according to any one of the first aspect. A rear cavity is formed on a first side of the wall, and a volume of the rear cavity is at least 10 times the volume of the cavity of the speaker module. The speaker module is located on a second side of the wall, and the vent of the speaker module communicates with the rear cavity.

The wall may also be referred to as a barrier plate or an installation wall. When the rear cavity on the first side of the wall is infinitely large, the wall may also be referred to as an infinitely large barrier plate.

According to the technical solution provided in the present disclosure, because the rear cavity is large enough, a low-frequency extension capability of the speaker module can be improved by making the vent of the speaker module communicate with the rear cavity, to ensure low-frequency performance of the speaker module. The speaker module does not need to be excessively large in volume, and does not need to occupy excessively large space.

In addition, within an operating frequency band of the speaker module, when the speaker vibrates, the passive vibration plate is driven to vibrate, and sound waves generated and radiated outward by the speaker and the passive vibration plate can be superposed. This increases a sound pressure level of the speaker module on the operating frequency band, and improves sound energy utilization.

In a possible implementation, the speaker module is installed on the wall, the wall is provided with a through hole, and the vent communicates with the rear cavity through the through hole.

In a possible implementation, the speaker system is used in a vehicle, the wall is a wall of the vehicle, the speaker module is located inside the vehicle, and the vent of the speaker module communicates with the outside of the vehicle. The outside of the vehicle forms an infinitely large rear cavity.

In a possible implementation, the speaker system is used in a room, the wall is a side wall, a top wall, or a bottom wall, the speaker module is located inside the room, and the vent of the speaker module communicates with the outside of the room. The outside of the room forms an infinitely large rear cavity.

In a possible implementation, the speaker system is used in a room, the wall is a side wall, a top wall, or a bottom wall, the speaker module is located inside one room, and the vent of the speaker module communicates with another room. A volume of space (or a rear cavity) inside the other room is at least 10 times the volume of the cavity of the speaker module.

According to a third aspect, the present disclosure provides a vehicle. The vehicle includes the speaker module according to any one of the first aspect, the speaker module is located inside the vehicle, and the vent of the speaker module communicates with the outside of the vehicle.

According to the technical solution provided in the present disclosure, because space outside the vehicle forms an infinitely large rear cavity, a low-frequency extension capability of the speaker module is improved by making the vent of the speaker module communicate with the outside of the vehicle, to ensure low-frequency performance of the speaker module. The speaker module does not need to be excessively large in volume, and the speaker module does not occupy excessively large space inside the vehicle.

In addition, within an operating frequency band of the speaker module, when the speaker vibrates, the passive vibration plate is driven to vibrate, and sound waves generated and radiated outward by the speaker and the passive vibration plate can be superposed. This increases a sound pressure level of the speaker module on the operating frequency band, and improves sound energy utilization.

In a possible implementation, the speaker module is installed on a wall of the vehicle, the wall of the vehicle is provided with a through hole, and the vent of the speaker module communicates with the outside of the vehicle through the through hole.

In a possible implementation, the speaker module is located above a tire of the vehicle, the vent faces the bottom of the vehicle, and one of the speakers and the passive vibration plate faces the left of the vehicle and the other one faces the right of the vehicle.

In a possible implementation, the speaker module is located in a trunk of the vehicle, the vent faces the bottom of the vehicle, and one of the speakers and the passive vibration plate faces the left of the vehicle and the other one faces the right of the vehicle.

In a possible implementation, the speaker module is located in a footwell region of the vehicle. The footwell region is a position used by a driver or a passenger to lay a foot, and may be a footwell region for a driver seat, or may be a footwell region for a front passenger seat. The vent of the speaker module faces the bottom of the vehicle, the speaker faces the rear of the vehicle, and the passive vibration plate faces the front of the vehicle.

In a possible implementation, the speaker module is located in a spare tire accommodation box of the vehicle, and the spare tire accommodation box is configured to accommodate a spare tire. The speaker module is located below a hub of the spare tire, the vent and the passive vibration plate face the bottom of the vehicle, and the speaker faces the top of the vehicle. The hub includes a frame structure, to facilitate radiating of a sound wave generated by the speaker module to a cockpit.

### BRIEF DESCRIPTION OF DRAWINGS

FIG. 1 is a diagram of a principle of an acoustic short circuit according to an embodiment of the present disclosure;

FIG. 2 is a diagram of a speaker module including a sealed sound box in a related technology according to an embodiment of the present disclosure;

FIG. 3 is a diagram of a speaker module that includes a sound box communicating with the outside of a vehicle in a related technology according to an embodiment of the present disclosure;

FIG. 4 is an equivalent circuit schematic of the speaker module shown in FIG. 3 according to an embodiment of the present disclosure;

FIG. 5 is a diagram of a speaker module according to an embodiment of the present disclosure;

FIG. 6 is a diagram of a speaker module according to an embodiment of the present disclosure;

FIG. 7 is a diagram of a speaker module according to an embodiment of the present disclosure;

FIG. 8 is a diagram of a speaker module according to an embodiment of the present disclosure;

FIG. 9 is an equivalent circuit schematic of a speaker module according to an embodiment of the present disclosure;

FIG. 10 is a diagram of sound pressure levels of a speaker, a passive vibration plate, and a speaker module according to an embodiment of the present disclosure;

FIG. 11 is a diagram of comparison between sound pressure levels of different speaker modules according to an embodiment of the present disclosure;

FIG. 12 is a three-dimensional diagram of a speaker module according to an embodiment of the present disclosure;

FIG. 13 is a three-dimensional diagram of a speaker module according to an embodiment of the present disclosure;

FIG. 14 is a sectional view of a speaker module according to an embodiment of the present disclosure;

FIG. 15 is an exploded view of a speaker module according to an embodiment of the present disclosure;

FIG. 16 is a diagram of a speaker module according to an embodiment of the present disclosure;

FIG. 17 is a diagram of a speaker module according to an embodiment of the present disclosure;

FIG. 18 is a diagram of a speaker module according to an embodiment of the present disclosure;

FIG. 19 is a diagram of a speaker module according to an embodiment of the present disclosure;

FIG. 20 is a diagram of a speaker module according to an embodiment of the present disclosure;

FIG. 21 is an equivalent circuit schematic of the speaker module shown in FIG. 20 according to an embodiment of the present disclosure;

FIG. 22 is a diagram of a speaker module according to an embodiment of the present disclosure;

FIG. 23 is a diagram of a speaker module according to an embodiment of the present disclosure;

FIG. 24 is a sectional view of a speaker module according to an embodiment of the present disclosure;

FIG. 25 is a three-dimensional diagram of a speaker according to an embodiment of the present disclosure;

FIG. 26 is a sectional view of a speaker according to an embodiment of the present disclosure;

FIG. 27 is a diagram of a vehicle according to an embodiment of the present disclosure;

FIG. 28 is a diagram of an installation position of a speaker module according to an embodiment of the present disclosure;

FIG. 29 is a diagram of an installation position of a speaker module according to an embodiment of the present disclosure; and

FIG. 30 is a diagram of an installation position of a speaker module according to an embodiment of the present disclosure.

### REFERENCE NUMERALS

100: speaker module; 200: rear cavity; 300: wall; 400: through hole; 500: trunk; 600: spare tire accommodation box; 700: spare tire; 710: hub;
1: frame body; 11: main portion; 110: cavity; 111: first opening; 112: second opening; 12: pipe; 120: vent;
2: speaker; 21: support assembly; 211: first support; 212: second support; 22: magnetic circuit assembly; 221: first magnetic conductive sheet; 222: magnet; 223: second magnetic conductive sheet; 23: vibration assembly; 231: voice coil; 232: vibration plate; 233: centering spider; 234: dust-proof cover;
3: passive vibration plate;
4: protective cover.

### DESCRIPTION OF EMBODIMENTS

A speaker is an electroacoustic transducer that converts electric energy into sound energy and radiates the sound energy in air to a distant place. The speaker generally includes a support assembly, a magnetic circuit assembly, and a vibration assembly. The support assembly is configured to support the magnetic circuit assembly and the vibration assembly, the magnetic circuit assembly is configured to drive the vibration assembly to vibrate, and the vibration assembly generates a sound when vibrating. The vibration assembly includes a vibration plate, and the vibration plate generates a sound when vibrating.

An acoustic short circuit may occur when the speaker is operating. The acoustic short circuit means that when the vibration plate of the speaker vibrates forward or backward, sound waves generated at the front and the rear of the vibration plate are in opposite phases, and in this case, the sound waves generated at the front and the rear of the vibration plate cancel each other out, resulting in a light sound. As shown in FIG. 1, a vivid understanding is as follows. When the vibration plate moves forward at a specific moment, air density at the front of the vibration plate is high, and air density at the rear is low. If there is no obstacle, air at the front of the vibration plate flows to the rear under effect of a pressure difference. In this case, air cannot travel forward.

The acoustic short circuit is related to a vibration frequency of the vibration plate. A lower vibration frequency indicates a stronger diffraction capability of a sound wave, the sound wave generated at the front of the vibration plate is more likely to be diffracted to the rear, and the sound wave generated at the rear of the vibration plate is more likely to be diffracted to the front. In this case, the sound wave at the front and the sound wave at the rear are more likely to cancel each other out, and the acoustic short circuit is more obvious.

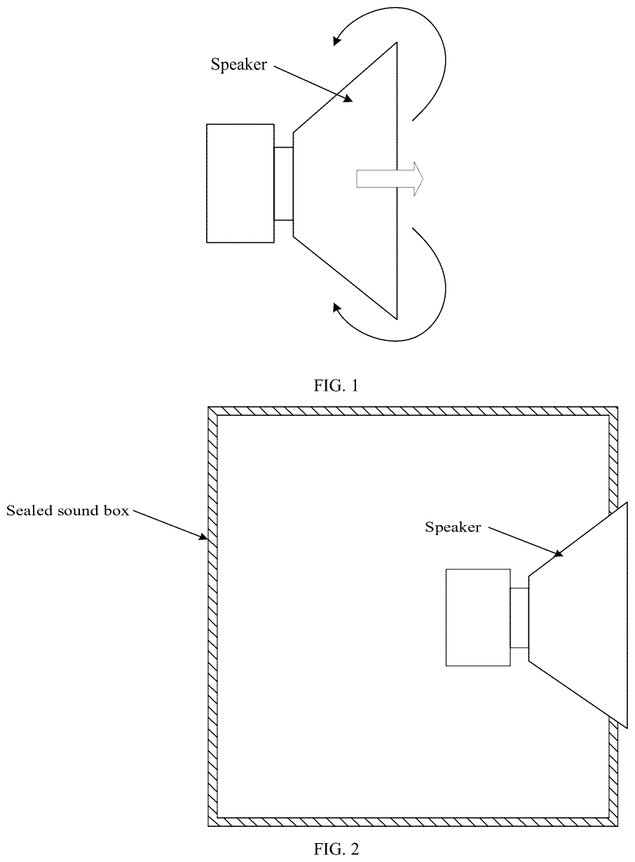

As shown in FIG. 2, a speaker is generally installed in a sealed sound box, to avoid an acoustic short circuit of the speaker. In this case, sound waves generated at the front and the rear of a vibration plate of the speaker are isolated from each other, so that the acoustic short circuit does not occur.

However, gas in the sealed sound box forms an air spring, and the presence of the air spring increases resistance that needs to be overcome when the vibration plate vibrates, causing an increase in a resonant frequency of the speaker (the vibration plate). Because a lower limit frequency of an operating frequency band of the speaker is near the resonant frequency of the speaker, the increase in the resonant frequency of the speaker causes an increase in the lower limit frequency of the operating frequency band of the speaker. Consequently, the operating frequency band of the speaker shifts to a higher frequency, resulting in a poor low-frequency extension capability of the speaker.

It may be understood that, a larger volume of the sound box indicates a smaller elastic force of an air spring formed by air in the sound box and less impact on the resonant frequency of the speaker. Therefore, a volume of the sound box may be increased, to improve low-frequency performance of the speaker and implement better low-frequency extension, for example, extension to 40 hertz (Hz) or lower. For example, the volume of the sound box is increased to more than 20 liters (L).

However, in some scenarios, a sound box is not supported to have a large volume. For example, for a speaker used in a vehicle, an excessively large sound box greatly occupies limited space inside the vehicle, causing a reduction in available space for a passenger or storage.

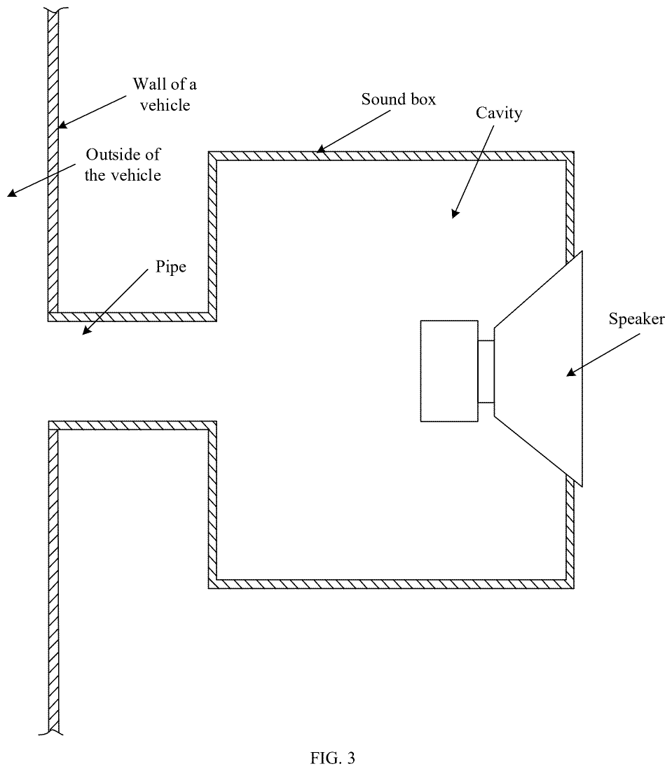

To improve low-frequency performance of a speaker without increasing a volume of a sound box, as shown in FIG. 3, a speaker module is provided in a related technology. The speaker module includes a sound box and a speaker. The sound box is installed on a wall of a vehicle, and leads to the outside of the vehicle through a pipe. In this case, space outside the vehicle forms an infinitely large rear cavity, which is equivalent to installing the speaker in an infinitely large sound box. There is no need to occupy large space inside the vehicle, and a low-frequency extension capability of the speaker is ensured.

However, the speaker module provided in the related technology has at least the following technical problems.

First, sound waves generated through vibration of the speaker and located inside the sound box are all radiated to the outside of the vehicle through the pipe. This reduces sound energy utilization.

Second, a sound pressure level of the speaker module on an operating frequency band may be decreased due to impact of a cavity of the sound box and the pipe.

The following explains and describes the second problem with reference to an equivalent circuit schematic of the speaker module in the related technology.

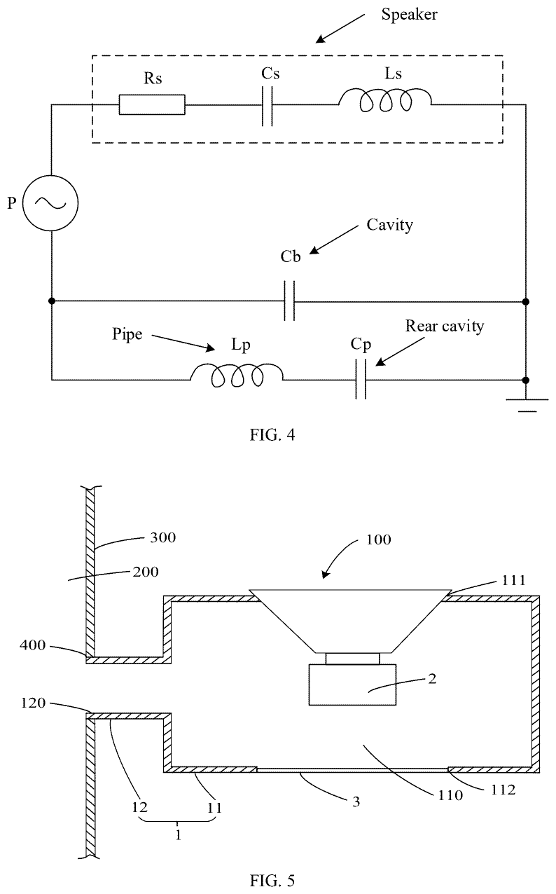

FIG. 4 is an equivalent circuit schematic of the speaker module shown in FIG. 3. In FIG. 4, a resistor Rs, a capacitor Cs, and an inductor Ls are equivalent electrical components of the speaker. A larger current flowing through the resistor Rs, the capacitor Cs, and the inductor Ls indicates a higher sound pressure level of the speaker. A capacitor Cb is an equivalent electrical component of the cavity, an inductor Lp is an equivalent electrical component of the pipe, and a capacitor Cp is an equivalent electrical component of the rear cavity. The rear cavity is space that is outside the vehicle and that communicates with the pipe. Because the rear cavity is infinitely large, the capacitor Cp is infinitely large. In this case, the capacitor Cp may be considered as a short circuit. Therefore, the capacitor Cp is not considered during circuit analysis.

A magnitude of a current flowing through the resistor Rs, the capacitor Cs, and the inductor Ls depends on a power supply p and impedance generated by a parallel circuit of the capacitor Cb and the inductor Lp. Because impedance of the capacitor Cb is gradually decreased as an alternating current frequency (which is equal to a vibration frequency of a vibration plate) of the power supply p is increased, and impedance of the inductor Lp is gradually increased as the alternating current frequency is increased, the impedance generated by the parallel circuit of the capacitor Cb and the inductor Lp is a maximum when the impedance of the capacitor Cb is equal to the impedance of the inductor Lp. In this case, it may be considered that the capacitor Cb and the inductor Lp generate parallel resonance, or that the pipe and the cavity generate resonance. When the impedance generated by the parallel circuit of the capacitor Cb and the inductor Lp is the maximum, the current flowing through the resistor Rs, the capacitor Cs, and the inductor Ls is significantly decreased, causing a decrease in a sound pressure level of the speaker.

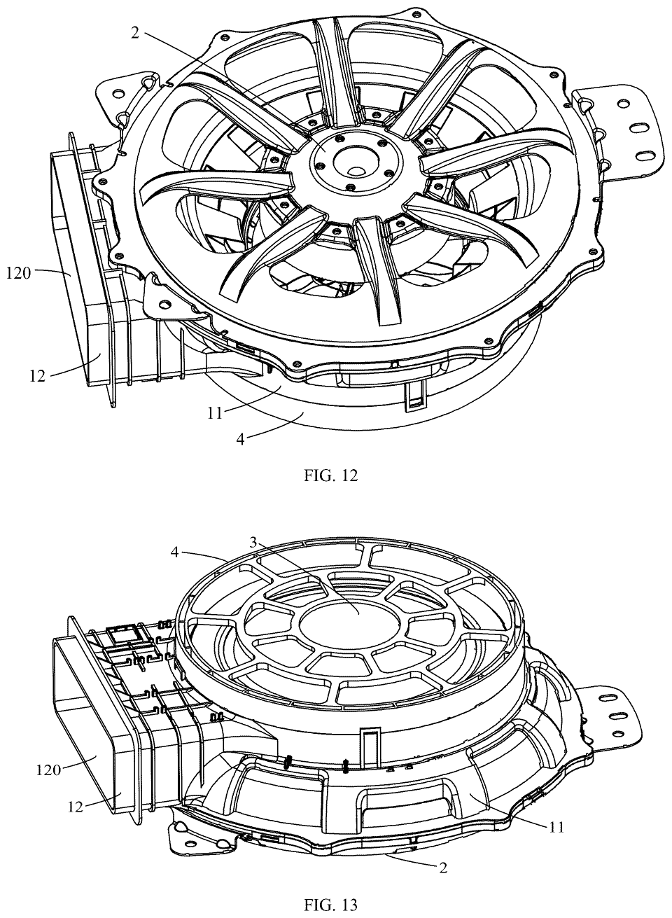

For ease of description, a frequency at which the capacitor Cb and the inductor Lp generate parallel resonance is referred to as a resonant frequency fp. If the resonant frequency fp is within the operating frequency band of the speaker module, a decrease in the sound pressure level of the speaker module on the operating frequency band is caused. Shapes and sizes of the cavity and the pipe need to be specially designed, to make the resonant frequency fp be outside the operating frequency band of the speaker. Generally, the pipe needs to be very short and a pipe diameter needs to be very large, and a volume of the cavity needs to be very small. It is clear that this limits an application scenario of the speaker module. In addition, as shown in FIG. 11, a curve representing a sound pressure level in a related technology 2 shows that, even if the resonant frequency fp is set to be outside the operating frequency band (20 Hz to 200 Hz) of the speaker module, the presence of the pipe and the cavity still causes a decrease in the sound pressure level of the speaker module on the operating frequency band.

In view of the foregoing technical problems, an embodiment of the present disclosure provides a speaker module 100. The speaker module 100 can implement good low-frequency extension, increase a sound pressure level of the speaker module 100 on an operating frequency band, and reduce limitations on shapes and sizes of a cavity and a pipe.

The following describes an example of the speaker module 100 provided in this embodiment of the present disclosure.

As shown in FIG. 5, the speaker module 100 includes a frame body 1, a speaker 2, and a passive vibration plate 3. The frame body 1 is provided with a first opening 111, a second opening 112, and a vent 120. The speaker 2 is located at the first opening 111, the passive vibration plate 3 is located at the second opening 112, a cavity 110 is formed among the frame body 1, the speaker 2, and the passive vibration plate 3, and the cavity 110 communicates with the vent 120.

The frame body 1 may also be referred to as a sound box, a cabinet, or the like, and is configured to support the speaker 2 and the passive vibration plate 3. The frame body 1 is provided with the first opening 111 and the second opening 112 configured to install the speaker 2 and the passive vibration plate 3. In some examples, the speaker 2 closes the first opening 111, and the passive vibration plate 3 closes the second opening 112. In addition, as shown in FIG. 5, the frame body 1 may be provided with a pipe 12. One end of the pipe 12 communicates with the cavity 110, and the other end of the pipe 12 is provided with the vent 120.

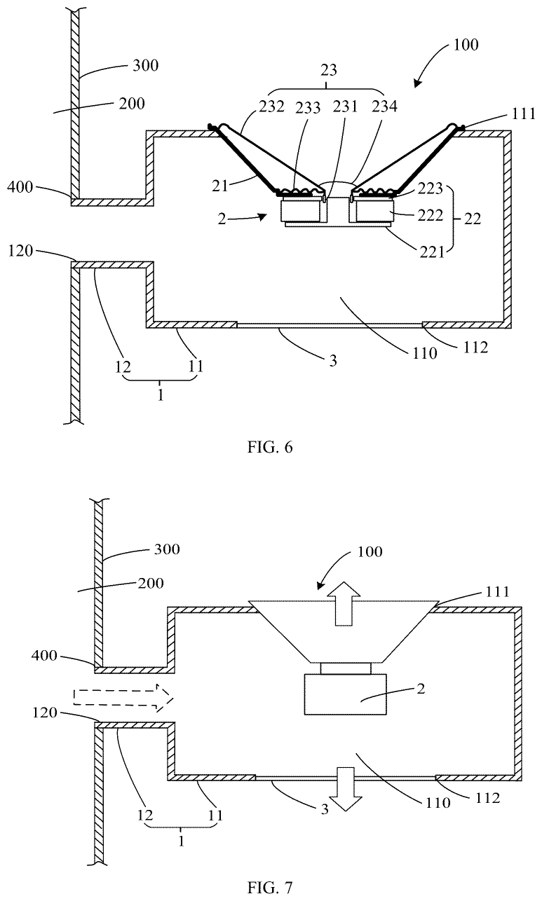

As shown in FIG. 6, the speaker 2 includes a vibration plate 232, and the vibration plate 232 vibrates to generate a sound. The cavity 110 may be formed among the vibration plate 232, the passive vibration plate 3, and the frame body 1. The vibration plate 232 may also be referred to as a diaphragm, a vibration membrane, or the like.

The passive vibration plate 3 is similar to the vibration plate 232, but does not need to be driven by an electrical signal during operation, and a sound is generated through vibration based on fluid-solid coupling. When the vibration plate 232 vibrates, the passive vibration plate 3 can vibrate under driving of the vibration plate 232. The passive vibration plate 3 may also be referred to as a passive vibration membrane or a PR. The vibration plate 232 and the passive vibration plate 3 generally include a plate body and a folding ring. A material of the plate body is generally paper, plastic, or metal, and the folding ring is generally rubber, cloth, or the like.

The speaker module 100 provided in this embodiment of the present disclosure has at least the following beneficial effects.

First, the frame body 1 of the speaker module 100 provided in this embodiment of the present disclosure is provided with the vent 120, and the vent 120 communicates with the cavity 110. In this case, a low-frequency extension capability of the speaker module 100 can be improved by making the vent 120 communicate with a rear cavity 200 with a volume that is large enough, to ensure low-frequency performance of the speaker module 100.

In some examples, the volume of the rear cavity 200 communicating with the vent 120 is at least 10 times a volume of the cavity 110. In other words, a ratio of the volume of the rear cavity 200 to the volume of the cavity 110 is greater than 10. It may also be considered that the volume of the cavity 110 includes a volume of the pipe 12.

In some examples, the rear cavity 200 is an infinitely large rear cavity. For example, the speaker module 100 is located inside a vehicle, and the rear cavity 200 is space outside the vehicle. For another example, the speaker module 100 is located indoors, and the rear cavity 200 is outdoor space.

Second, the passive vibration plate 3 is disposed in the speaker module 100 provided in this embodiment of the present disclosure. The passive vibration plate 3 can vibrate under driving of the speaker 2, so that the passive vibration plate 3 is used as a secondary sound source to radiate a sound wave outward (to the outside of the frame body 1). In addition, resonant frequencies of the speaker 2 and the passive vibration plate 3 are properly set, so that within the operating frequency band of the speaker module 100, sound waves radiated outward by the passive vibration plate 3 and the speaker 2 can be superposed. This increases the sound pressure level of the speaker module 100 on the operating frequency band, and improves sound energy utilization.

In addition, for a problem of a decrease in the sound pressure level of the speaker module on the operating frequency band caused by resonance of the cavity and the pipe in the related technology, because the passive vibration plate 3 in the speaker module 100 provided in this embodiment of the present disclosure can increase the sound pressure level of the speaker module 100 on the operating frequency band, the passive vibration plate 3 can compensate for a decrease in the sound pressure level of the speaker module 100 caused by the cavity and the pipe even if a resonant frequency fp of the cavity and the pipe is within the operating frequency band of the speaker module 100. In this way, the resonant frequency fp of the cavity and the pipe may not be required to be outside the operating frequency band of the speaker module 100. In other words, limitations on the shapes and the sizes of the cavity and the pipe are reduced, which helps extend an application scenario of the speaker module 100.

Certainly, the resonant frequency fp of the cavity and the pipe may still be outside the operating frequency band of the speaker module 100. This is not limited in embodiments of the present disclosure.

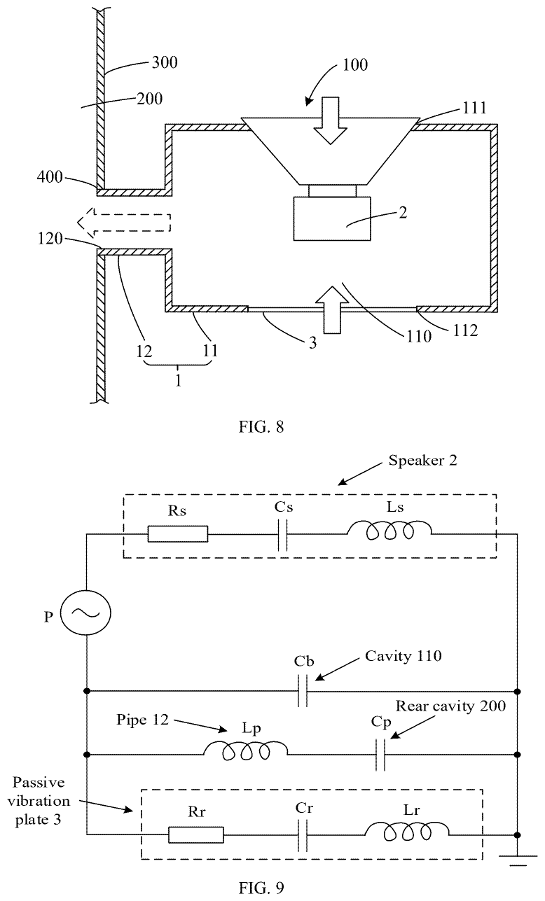

The following describes an example of an operating process of the speaker module 100 with reference to FIG. 7 and FIG. 8.

As shown in FIG. 7, at a same moment, the speaker 2 and the passive vibration plate 3 simultaneously vibrate outward. In this case, sound waves radiated by the speaker 2 and the passive vibration plate 3 to outer sides of the frame body 1 are in a same phase, and the sound waves radiated by the speaker 2 and the passive vibration plate 3 can be superposed, thereby increasing the sound pressure level of the speaker module 100. In addition, in a process in which the speaker 2 and the passive vibration plate 3 vibrate outward, the volume of the cavity 110 becomes larger, and pressure becomes smaller. Under effect of a pressure difference, gas in the rear cavity 200 flows into the cavity 110 through the vent 120, and the gas flowing into the cavity 110 increases the pressure in the cavity 110, so that differences between the pressure in the cavity 110 and both pressure on an outer side of the speaker 2 and pressure on an outer side of the passive vibration plate 3 are decreased. In this way, resistance encountered when the speaker 2 and the passive vibration plate 3 vibrate outward is decreased, which facilitates low-frequency extension of the speaker module 100.

As shown in FIG. 8, at a same moment, the speaker 2 and the passive vibration plate 3 simultaneously vibrate inward. In this case, sound waves radiated by the speaker 2 and the passive vibration plate 3 to outer sides of the frame body 1 are in a same phase, and the sound waves radiated by the speaker 2 and the passive vibration plate 3 can be superposed, thereby increasing the sound pressure level of the speaker module 100. In addition, in a process in which the speaker 2 and the passive vibration plate 3 vibrate inward, the volume of the cavity 110 becomes smaller, and pressure becomes larger. Under effect of a pressure difference, gas in the cavity 110 flows into the rear cavity 200 through the vent 120, so that the pressure in the cavity 110 becomes smaller. In this way, resistance encountered when the speaker 2 and the passive vibration plate 3 vibrate inward is decreased, which facilitates low-frequency extension of the speaker module 100.

It may be understood that, when the speaker 2 and the passive vibration plate 3 simultaneously vibrate, a sound wave radiated outward by the speaker 2 and a sound wave radiated outward by the passive vibration plate 3 may be in a same phase or may be in opposite phases, that is, may be superposed or may cancel each other out.

Further, as shown in FIG. 7 and FIG. 8, when the speaker 2 and the passive vibration plate 3 simultaneously vibrate outward or inward, sound waves radiated outward by the speaker 2 and the passive vibration plate 3 are in a same phase, and superposition effect is presented. However, if one of the speakers 2 and the passive vibration plate 3 vibrates outward and the other one vibrates inward, sound waves radiated outward by the speaker 2 and the passive vibration plate 3 are in opposite phases, and cancellation effect is presented.

It should be noted that, in this embodiment of the present disclosure, that sound waves radiated outward by the speaker 2 and the passive vibration plate 3 are in a same phase does not mean that phases of the sound waves radiated outward by the speaker 2 and the passive vibration plate 3 are completely the same, but means that a phase difference between the sound waves radiated outward by the speaker 2 and the passive vibration plate 3 ranges from −π/2 to π/2. When the phase difference is greater than −π/2 and less than π/2, the sound waves radiated outward by the speaker 2 and the passive vibration plate 3 are superposed.

Similarly, in this embodiment of the present disclosure, that sound waves radiated outward by the speaker 2 and the passive vibration plate 3 are in opposite phases does not mean that a phase difference between the sound waves radiated outward by the speaker 2 and the passive vibration plate 3 is strictly equal to π, but means that the phase difference between the sound waves radiated outward by the speaker 2 and the passive vibration plate 3 ranges from −π to −π/2 or from π/2 to π. When the phase difference is within this range, the sound waves radiated outward by the speaker and the passive vibration plate 3 cancel each other out.

The following describes how to enable a sound wave radiated outward by the speaker 2 and a sound wave radiated outward by the passive vibration plate 3 to be superposed within the operating frequency band of the speaker module 100.

It can be learned from theoretical calculation and experimental verification that when an operating frequency of the speaker module 100 is less than both a resonant frequency fs of the speaker 2 and a resonant frequency fr of the passive vibration plate 3, a sound wave radiated outward by the speaker 2 and a sound wave radiated outward by the passive vibration plate 3 are in opposite phases, and cancellation effect is presented.

When the operating frequency of the speaker module 100 is greater than both the resonant frequency fs of the speaker 2 and the resonant frequency fr of the passive vibration plate 3, a sound wave radiated outward by the speaker 2 and a sound wave radiated outward by the passive vibration plate 3 are in opposite phases, and cancellation effect is presented.

When the resonant frequency fs of the speaker 2 is greater than the resonant frequency fr of the passive vibration plate 3, and the operating frequency of the speaker module 100 is less than the resonant frequency fs of the speaker 2 and greater than the resonant frequency fr of the passive vibration plate 3, a sound wave radiated outward by the speaker 2 and a sound wave radiated outward by the passive vibration plate 3 are in a same phase, and superposition effect is presented.

When the resonant frequency fs of the speaker 2 is less than the resonant frequency fr of the passive vibration plate 3, and the operating frequency of the speaker module 100 is greater than the resonant frequency fs of the speaker 2 and less than the resonant frequency fr of the passive vibration plate 3, a sound wave radiated outward by the speaker 2 and a sound wave radiated outward by the passive vibration plate 3 are in a same phase, and superposition effect is presented.

Because the resonant frequency fs of the speaker 2 is near a lower limit frequency of the operating frequency band of the speaker module 100, it may be first assumed that the resonant frequency fs of the speaker 2 is equal to the lower limit frequency of the operating frequency band of the speaker module 100.

If the resonant frequency fr of the passive vibration plate 3 is set to be less than the resonant frequency fs of the speaker 2, a sound wave radiated outward by the speaker 2 and a sound wave radiated outward by the passive vibration plate 3 are in a same phase only when the speaker module 100 operates on a frequency band less than the resonant frequency fs of the speaker 2. In this case, the passive vibration plate 3 can improve the low-frequency extension capability of the speaker module 100. When the speaker module 100 operates on a frequency band greater than the resonant frequency fs of the speaker 2, that is, operates on the operating frequency band of the speaker module 100, a sound wave radiated outward by the speaker 2 and a sound wave radiated outward by the passive vibration plate 3 are in opposite phases, and the passive vibration plate 3 cannot increase the sound pressure level of the speaker module 100 on the operating frequency band.

If the resonant frequency fr of the passive vibration plate 3 is set to be greater than the resonant frequency fs of the speaker 2, a sound wave radiated outward by the speaker 2 and a sound wave radiated outward by the passive vibration plate 3 are in a same phase when the speaker module 100 operates on a frequency band greater than the resonant frequency fs of the speaker 2 and less than the resonant frequency fr of the passive vibration plate 3. The frequency band is within the operating frequency band of the speaker module 100.

In conclusion, the resonant frequency fr of the passive vibration plate 3 needs to be greater than the resonant frequency fs of the speaker 2, to enable a sound wave radiated outward by the speaker 2 and a sound wave radiated outward by the passive vibration plate 3 to be superposed within the operating frequency band of the speaker module 100.

In addition, it can be further learned from the foregoing descriptions that, if the speaker module 100 operates on a frequency band greater than the resonant frequency fr of the passive vibration plate 3, a sound wave radiated outward by the passive vibration plate 3 and a sound wave radiated outward by the speaker 2 cancel each other out, and the passive vibration plate 3 causes a decrease in the sound pressure level of the speaker module 100. Therefore, the operating frequency band of the speaker module 100 depends on the resonant frequency fr of the passive vibration plate 3 to some extent.

In some examples, the resonant frequency fr of the passive vibration plate 3 may be set to be greater than or equal to an upper limit frequency of the operating frequency band of the speaker module 100, to enable the speaker module 100 to have a high sound pressure level on the entire operating frequency band. In other words, a ratio of the resonant frequency of the passive vibration plate 3 to the upper limit frequency of the operating frequency band of the speaker module 100 is greater than or equal to 1.

In this way, within the entire operating frequency band (or a second half of the entire operating frequency band) of the speaker module 100, a sound wave radiated outward by the speaker 2 and a sound wave radiated outward by the passive vibration plate 3 are superposed.

In addition, when the speaker module 100 operates on a frequency band greater than the resonant frequency fr of the passive vibration plate 3, a sound wave radiated by the passive vibration plate 3 and a sound wave radiated by the speaker 2 cancel each other out, causing a decrease in the sound pressure level of the speaker module 100, but there is a process for the decrease in the sound pressure level of the speaker module 100. Therefore, when the speaker module 100 operates on a frequency band slightly greater than the resonant frequency fr of the passive vibration plate 3, the speaker module 100 still has a high sound pressure level. Therefore, the resonant frequency of the passive vibration plate 3 may alternatively be slightly less than the upper limit frequency of the operating frequency band of the speaker module 100. In some examples, the ratio of the resonant frequency of the passive vibration plate 3 to the upper limit frequency of the operating frequency band of the speaker module 100 is greater than 0.8.

In some examples, because the passive vibration plate 3 has greatest amplitude at the resonant frequency, the resonant frequency fr of the passive vibration plate 3 shall not exceed the upper limit frequency of the operating frequency band of the speaker module 100 by too much for utilization of a sound wave generated by the passive vibration plate 3 near the resonant frequency. In some examples, the ratio of the resonant frequency fr of the passive vibration plate 3 to the upper limit frequency of the operating frequency band of the speaker module 100 is less than 2.

In some examples, the ratio of the resonant frequency fr of the passive vibration plate 3 to the upper limit frequency of the operating frequency band of the speaker module 100 is less than 1.5. Further, the ratio is less than 1.2.

In some examples, a ratio of the resonant frequency of the passive vibration plate 3 to the resonant frequency of the speaker 2 is greater than 1.5. Further, in some examples, the ratio is greater than 2.

To adjust the resonant frequency fr of the passive vibration plate 3 and the resonant frequency fs of the speaker 2 to the foregoing relationship, in some examples, a ratio of mass of the passive vibration plate 3 to mass of a vibration assembly 23 of the speaker 2 may be set to be less than 0.5.

The mass of the passive vibration plate 3 is a sum of mass of the plate body and the folding ring of the passive vibration plate 3. The mass of the vibration assembly 23 is a sum of mass of a voice coil 231, the vibration plate 232, and a centering spider 233 that are included in the vibration assembly 23, and in some examples, may further include mass of a dust-proof cover 234.

Further, in some examples, the ratio of the mass of the passive vibration plate 3 to the mass of the vibration assembly 23 is less than 0.2.

To achieve better superposition effect of a sound wave radiated outward by the speaker 2 and a sound wave radiated outward by the passive vibration plate 3, in some examples, a ratio of an area of the passive vibration plate 3 to an area of the vibration plate 232 of the speaker 2 is greater than 0.2 and less than 2. Further, the ratio of the area of the passive vibration plate 3 to the area of the vibration plate 232 of the speaker 2 is greater than 0.5 and less than 2.

With reference to an equivalent circuit schematic of the speaker module 100 provided in this embodiment of the present disclosure, the following describes a change in the speaker module 100 after the passive vibration plate 3 is introduced.

FIG. 9 is an equivalent circuit schematic of the speaker module shown in FIG. 5 to FIG. 8. In FIG. 9, a resistor Rs, a capacitor Cs, and an inductor Ls are equivalent electrical components of the speaker 2. For the speaker 2, a larger current flowing through the resistor Rs, the capacitor Cs, and the inductor Ls indicates a higher sound pressure level of the speaker 2. A capacitor Cb is an equivalent electrical component of the cavity 110, an inductor Lp is an equivalent electrical component of the pipe 12, and a capacitor Cp is an equivalent electrical component of the rear cavity 200. When the rear cavity 200 is very large, the capacitor Cp is infinitely large. In this case, the capacitor Cp may be considered as a short circuit. Therefore, the capacitor Cp is not considered during circuit analysis. A resistor Rr, a capacitor Cr, and an inductor Lr are equivalent electrical components of the passive vibration plate 3. Similarly, for the passive vibration plate 3, a larger current flowing through the resistor Rr, the capacitor Cr, and the inductor Lr indicates a higher sound pressure level of the passive vibration plate 3.

It can be learned from FIG. 9 that, when the passive vibration plate 3 is introduced, a branch circuit is connected in parallel with a parallel circuit of the capacitor Cb and the inductor Lp. The branch circuit includes the resistor Rr, the capacitor Cr, and the inductor Lr that are connected in series. It is clear that this decreases impedance of a loop in which the electrical components corresponding to the speaker 2 are located, and increases a sound pressure level of the speaker 2.

In other words, an increase in the sound pressure level of the speaker module 100 is affected by the following two aspects.

A first aspect is sound waves radiated outward by the speaker 2 and the passive vibration plate 3 are superposed, so that the sound pressure level of the speaker module 100 is increased.

A second aspect is the passive vibration plate 3 is introduced, so that the sound pressure level of the speaker 2 is increased.

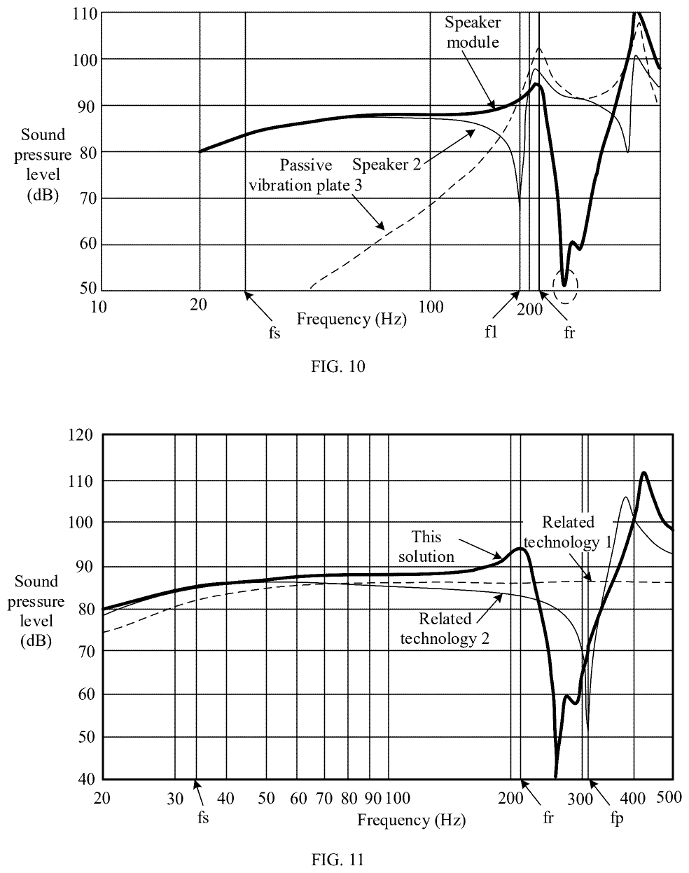

As shown in FIG. 10, this embodiment of the present disclosure provides a diagram of comparison between a sound pressure level of a sound wave radiated outward by the speaker 2, a sound pressure level of a sound wave radiated outward by the passive vibration plate 3, and a sound pressure level radiated outward by the speaker module 100.

It can be learned from FIG. 10 that, there is an obvious decrease in a sound pressure level of a sound wave generated by the speaker 2 on a second half of an operating frequency band, and a sound pressure level of a sound wave generated by the speaker 2 at a first frequency fl is a minimum. The minimum occurs because the cavity 110, the pipe 12 (if any), and the passive vibration plate 3 generate resonance at the first frequency fl. Correspondingly, in the circuit schematic shown in FIG. 9, this may be understood as follows. Impedance generated by a branch in which Cb is located, a branch in which Lp is located, and a branch in which Cr is located reaches a maximum at the first frequency fl. The first frequency fl may also be referred to as a resonant frequency of a system including the cavity 110, the pipe 12 (if any), and the passive vibration plate 3.

To increase a sound pressure level of the speaker module 100 at the first frequency fl, as shown in FIG. 10, the resonant frequency fr of the passive vibration plate 3 is set to be greater than the first frequency fl. In this way, when the speaker module 100 operates at the first frequency fl, a sound wave generated by the passive vibration plate 3 and a sound wave generated by the speaker 2 are superposed, so that the sound pressure level of the speaker module 100 is increased.

In addition, it can be further learned from FIG. 10 that, a sound wave radiated outward by the passive vibration plate 3 after the resonant frequency fr of the passive vibration plate 3 and a sound wave radiated outward by the speaker 2 cancel each other out. In this case, the speaker module 100 has a very low sound pressure level, as shown in a part encircled by a dashed line in FIG. 10. However, because a frequency corresponding to the part is outside the operating frequency band of the speaker module 100, a decrease in the sound pressure level of the speaker module 100 on the operating frequency band is not caused.

As shown in FIG. 11, this embodiment of the present disclosure provides a diagram of comparison between sound pressure levels in this solution, a related technology 1, and the related technology 2. The related technology 1 represents the technical solution in which the speaker is installed in the sealed box shown in FIG. 2, and the related technology 2 represents the technical solution shown in FIG. 3.

It can be learned from FIG. 11 that, in comparison with the related technology 1, because the speaker module 100 provided in this embodiment of the present disclosure is provided with the vent 120, and the vent 120 communicates with the rear cavity 200 that is large enough, the low-frequency extension capability of the speaker module 100 provided in this embodiment of the present disclosure is significantly better than the low-frequency extension capability of the speaker in the related technology 1. Further, below 40 Hz, a sound pressure level of the speaker module 100 provided in this embodiment of the present disclosure is increased by at least 3 dB in comparison with a sound pressure level of the speaker in the related technology 1.

In comparison with the related technology 2, because both speaker modules communicate with a rear cavity 200 that is large enough, on a first half (20 Hz to 50 Hz) of the operating frequency band, a sound pressure level of the speaker module 100 provided in this embodiment of the present disclosure is not greatly different from that of the speaker module in the related technology 2. However, on a second half (50 Hz to 200 Hz) of the operating frequency band, there is an obvious increase in a sound pressure level of the speaker module 100 provided in this embodiment of the present disclosure, due to an increase in a sound pressure level of the speaker 2 and superposition effect of a sound wave generated through vibration of the passive vibration plate 3 in the speaker module 100 provided in this embodiment of the present disclosure.

In addition, it can be learned from FIG. 11 that, although the resonant frequency fp of the pipe and the cavity is set to be far greater than an upper limit frequency (200 Hz) of the operating frequency band of the speaker module in the related technology 2, the pipe and the cavity still cause a decrease in a sound pressure level of the speaker module in the related technology 2 on a second half (for example, 100 Hz to 200 Hz) of the operating frequency band.

In some examples, a ratio of the resonant frequency fp of the cavity 110 and the pipe 12 to the resonant frequency fr of the passive vibration plate 3 is greater than 0.5.

In this way, the resonant frequency fr of the passive vibration plate 3 is near the resonant frequency fp of the cavity 110 and the pipe 12, so that the passive vibration plate 3 can effectively compensate for a decrease in the sound pressure level of the speaker module caused by the cavity 110 and the pipe 12. This maximizes a function of the passive vibration plate 3. Alternatively, when fp is large (for example, fp is greater than 2), the resonant frequency fp of the cavity 110 and the pipe 12 is outside the operating frequency band of the speaker module. This can reduce impact of resonance of the pipe 12 and the cavity 110 on the sound pressure level of the speaker module on the operating frequency band.

Further, in some examples, the ratio of the resonant frequency fp of the cavity 110 and the pipe 12 to the resonant frequency fr of the passive vibration plate 3 is greater than 0.7.

In some examples, the ratio of the resonant frequency fp of the cavity 110 and the pipe 12 to the resonant frequency fr of the passive vibration plate 3 is less than 5. Further, the ratio is less than 3.

It should be noted that, the resonant frequency fs of the speaker 2 and the resonant frequency fr of the passive vibration plate 3 in this embodiment of the present disclosure are operating resonant frequencies of the speaker 2 and the passive vibration plate 3. In addition to the operating resonant frequencies, the speaker 2 and the passive vibration plate 3 have natural frequencies (or referred to as eigenfrequencies). The natural frequencies are resonant frequencies that the speaker 2 and the passive vibration plate 3 have when the speaker 2 and the passive vibration plate 3 are not installed on the frame body 1.

After the speaker 2 and the passive vibration plate 3 are installed on the frame body 1, the speaker 2 is affected by the passive vibration plate 3, the cavity 110, and the pipe 12, and the passive vibration plate 3 is affected by the speaker 2, the cavity 110, and the pipe 12. Therefore, the natural frequencies are different from the operating resonant frequencies.

The following describes in more detail an example of a structure of the speaker module 100 provided in embodiments of the present disclosure.

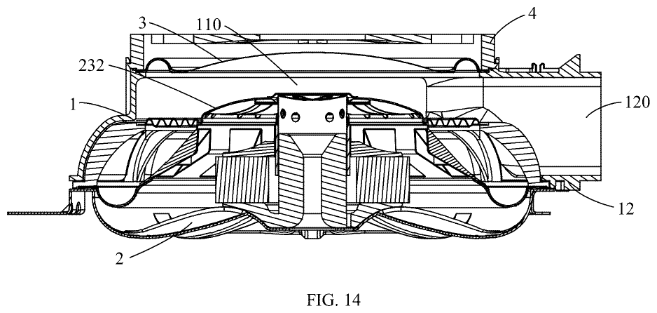

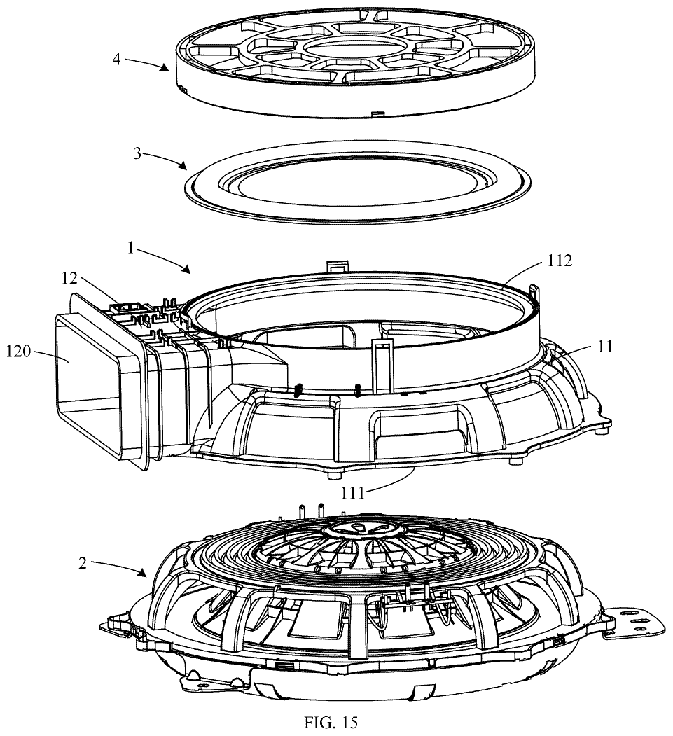

FIG. 12 to FIG. 15 are physical diagrams of a speaker module 100 according to an embodiment of the present disclosure.

In some examples, as shown in FIG. 5 to FIG. 8 and FIG. 12 to FIG. 19, a frame body 1 includes a main portion 11 and a pipe 12, the main portion 11 is provided with a first opening 111 and a second opening 112, and a cavity 110 is formed among the main portion 11, a speaker 2, and a passive vibration plate 3. One end of the pipe 12 communicates with the cavity 110, and the other end of the pipe 12 is provided with a vent 120.

A position at which the pipe 12 is connected to the main portion 11 is not limited in embodiments of the present disclosure. In some examples, as shown in FIG. 5 to FIG. 8 and FIG. 19, it is defined as follows. The first opening 111 is located at an end part of the main portion 11. In this case, the pipe 12 is connected to a side of the main portion 11.

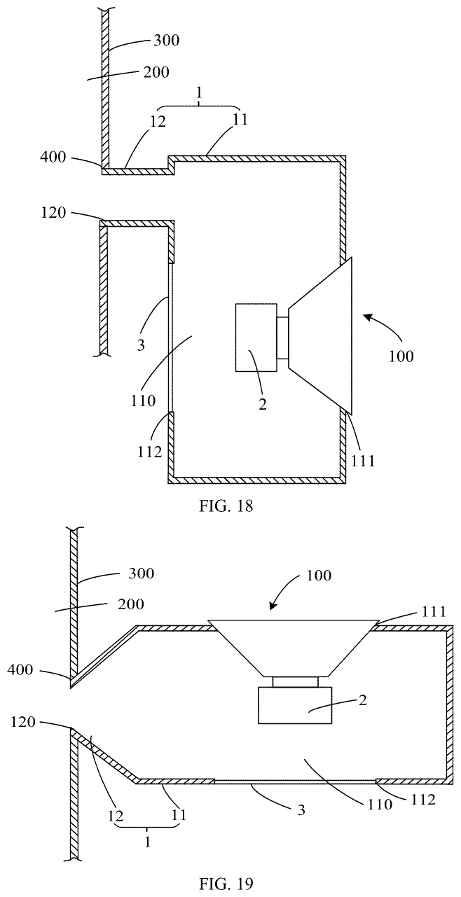

In some other examples, as shown in FIG. 18, the pipe 12 is connected to an end part of the main portion 11, and the end part is opposite to an end part at which the first opening 111 is located.

In some other examples, the pipe 12 may alternatively be connected to an end part at which the first opening 111 is located.

A form of the pipe 12 is not limited in embodiments of the present disclosure. In some examples, the pipe 12 is a straight pipe. In some other examples, the pipe 12 is a curved pipe. In some examples, as shown in FIG. 5 to FIG. 8 and FIG. 12 to FIG. 18, a pipe diameter of the pipe 12 remains unchanged. In some other examples, as shown in FIG. 19, a pipe diameter of the pipe 12 is gradually decreased along a direction away from the main portion 11.

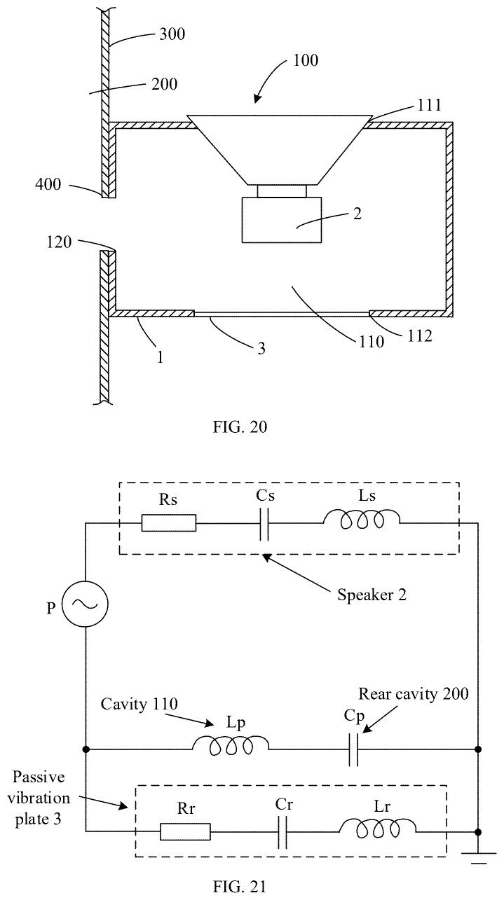

Certainly, in some other examples, as shown in FIG. 20, a frame body 1 may alternatively not be provided with a pipe 12. FIG. 21 is an equivalent circuit schematic of a speaker module 100 shown in FIG. 20. In FIG. 21, an electrical component corresponding to a cavity 110 is an inductor Lp. In this case, the cavity 110 functions as a pipe.

Relative positions of the speaker 2 and the passive vibration plate 3 on the frame body 1 are not limited in embodiments of the present disclosure. The following describes examples.

In some examples, as shown in FIG. 5, the speaker 2 is opposite to the passive vibration plate 3. In this way, space occupied by the speaker 2 and the passive vibration plate 3 can be reduced, which helps reduce a volume of the speaker module 100.

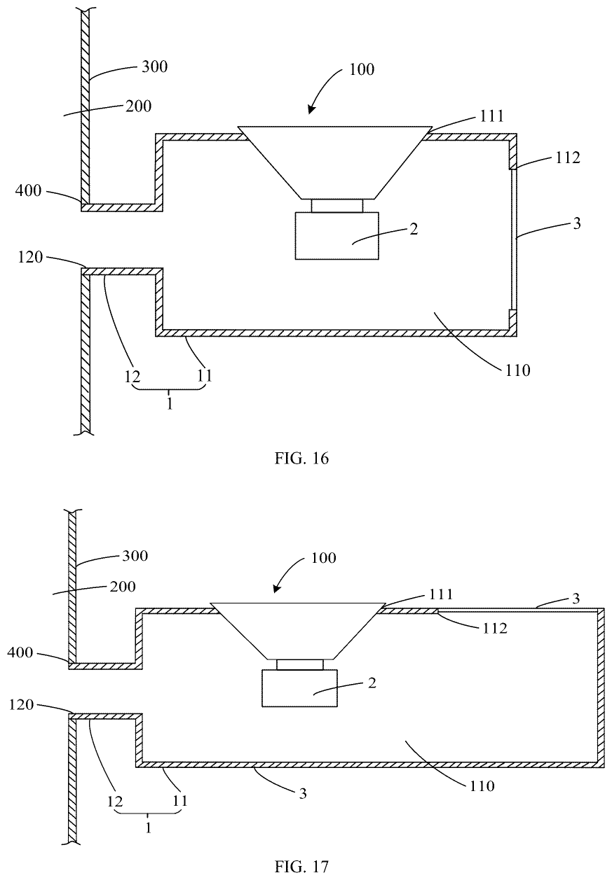

In some examples, as shown in FIG. 16, the speaker 2 and the passive vibration plate 3 are located on two adjacent frame walls respectively.

In some examples, as shown in FIG. 17, the speaker 2 and the passive vibration plate 3 are located on a same frame wall.

It should be noted that, the foregoing several positions of the speaker 2 and the passive vibration plate 3 are merely examples for description, and the speaker 2 and the passive vibration plate 3 may alternatively be located at other positions. This is not limited in embodiments of the present disclosure.

Quantities of speakers 2 and passive vibration plates 3 are not limited in embodiments of the present disclosure. The following describes examples.

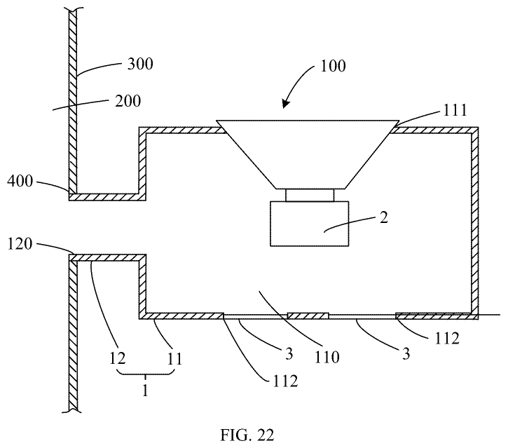

In some examples, as shown in FIG. 5, there is one speaker 2 and one passive vibration plate 3. In some examples, as shown in FIG. 22, there is one speaker 2 and a plurality of passive vibration plates 3. For example, the speaker 2 may be opposite to the plurality of (for example, two) passive vibration plates 3. In some examples, there is one passive vibration plate 3 and a plurality of speakers 2. In some examples, there are a plurality of passive vibration plates 3 and a plurality of speakers 2, and quantities of passive vibration plates 3 and speakers 2 may be the same or may be different. The plurality of speakers 2 may be opposite to the plurality of passive vibration plates 3 respectively.

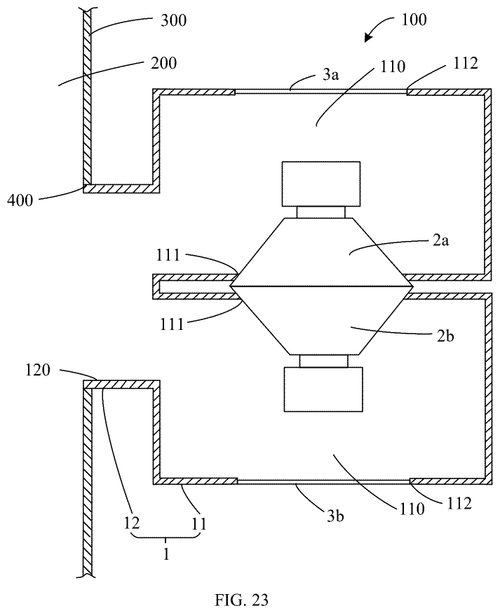

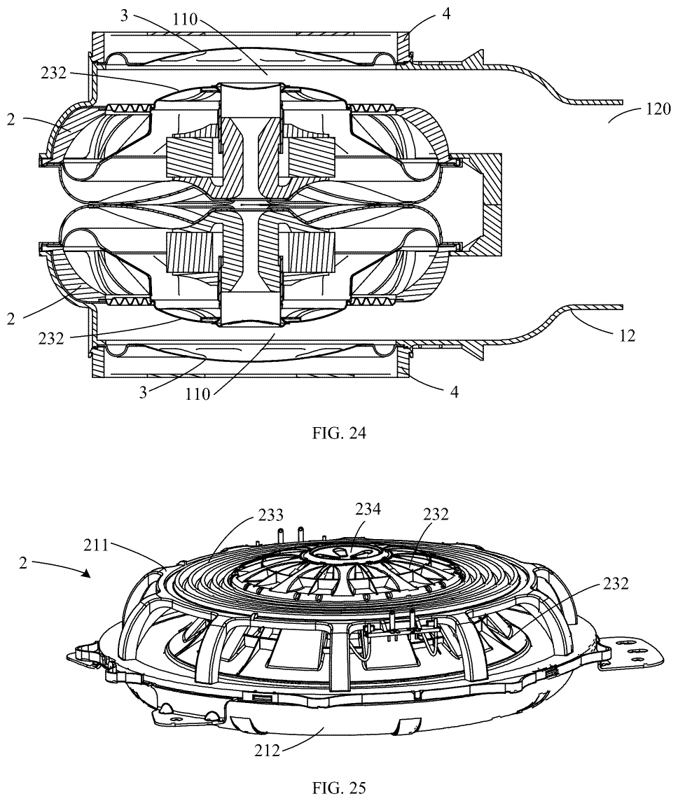

The following describes an example of a speaker module 100 including two speakers 2. As shown in FIG. 23 and FIG. 24, there are two first openings 111, and the two first openings 111 are opposite to each other. The speakers 2 include a first speaker 2a and a second speaker 2b, the first speaker 2a and the second speaker 2b are located at the two first openings 111 respectively, and the first speaker 2a abuts against the second speaker 2b.

In this way, vibration directions of vibration plates 232 in the two speakers 2 are opposite. In other words, the two vibration plates 232 either move toward each other or move away from each other. In this case, reaction forces caused by vibration of the vibration plates 232 cancel each other out, and vibration of support assemblies of the two speakers 2 is small. This helps decrease resonant amplitude of the speaker module, and can improve sound quality.

In some examples, as shown in FIG. 23 and FIG. 24, there are two second openings 112, a passive vibration plate 3 includes a first passive vibration plate 3a and a second passive vibration plate 3b, and the first passive vibration plate 3a and the second passive vibration plate 3b are located at the two second openings 112 respectively. One cavity 110 is formed among the first speaker 2a, the first passive vibration plate 3a, and a frame body 1, one cavity 110 is formed among the second speaker 2b, the second passive vibration plate 3b, and the frame body 1, and each of the two cavities 110 communicates with a vent 120.

To protect the passive vibration plate 3 to some extent and reduce a possibility that the passive vibration plate 3 is damaged, in some examples, as shown in FIG. 12 to FIG. 15, the speaker module 100 further includes a protective cover 4. The protective cover 4 is connected to the frame body 1 and covers the passive vibration plate 3. In addition, the protective cover 4 includes a frame structure. Therefore, the protective cover 4 does not seal an outer side of the passive vibration plate 3, and does not affect vibration of the passive vibration plate 3.

The following describes an example of a structure of the speaker 2 provided in embodiments of the present disclosure.

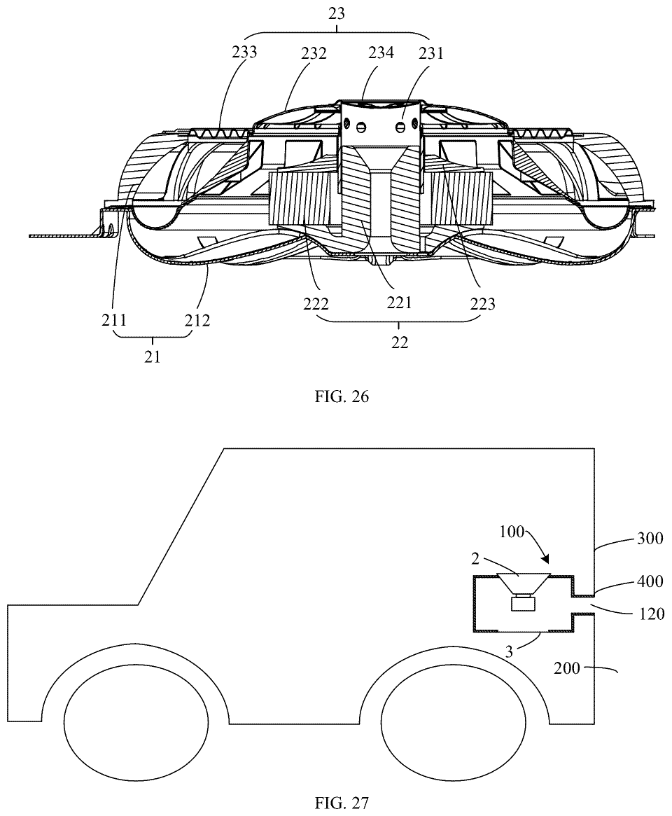

As shown in FIG. 6, FIG. 25, and FIG. 26, a speaker 2 provided in an embodiment of the present disclosure is a moving coil speaker, and the speaker 2 includes a support assembly 21, a magnetic circuit assembly 22, and a vibration assembly 23. The support assembly 21 supports the magnetic circuit assembly 22 and the vibration assembly 23, the magnetic circuit assembly 22 is configured to drive the vibration assembly 23 to vibrate, and the vibration assembly 23 generates a sound when vibrating.

In some examples, as shown in FIG. 25 and FIG. 26, the support assembly 21 includes a first support 211 and a second support 212. The first support 211 is located inside a frame body 1, and the second support 212 is located outside the frame body 1. The first support 211 and the second support 212 are fastened together, and protect and support the magnetic circuit assembly 22 and the vibration assembly 23.

In some examples, as shown in FIG. 6 and FIG. 26, the magnetic circuit assembly 22 includes a first magnetic conductive sheet 221, a magnet 222, and a second magnetic conductive sheet 223. The first magnetic conductive sheet 221, the magnet 222, and the second magnetic conductive sheet 223 are coaxially disposed, and the magnet 222 is located between the first magnetic conductive sheet 221 and the second magnetic conductive sheet 223. The magnetic circuit assembly 22 is configured to generate a changing magnetic field, to drive the vibration assembly 23 to vibrate.

In some examples, as shown in FIG. 6, FIG. 25, and FIG. 26, the vibration assembly 23 includes a voice coil 231, a vibration plate 232, and a centering spider 233. The voice coil 231 is connected to the vibration plate 232. The magnetic circuit assembly 22 drives the voice coil 231 to move. The voice coil 231 drives, when moving, the vibration plate 232 to vibrate. The centering spider 233 is connected to the vibration plate 232 and the support assembly 21 (for example, the first support 211). The centering spider 233 is configured to position the voice coil 231 and the vibration plate 232, to ensure that the voice coil 231 and the vibration plate 232 move back and forth along an axial direction. In addition, the centering spider 233 has elasticity, and can affect a resonant frequency of the speaker 2 to some extent. In addition, the centering spider 233 can have a dust-proof function. The centering spider 233 may also be referred to as a damper.

In some examples, as shown in FIG. 25, the centering spider 233 is in a ring shape, an inner side of the centering spider 233 is connected, for example, bonded, to the vibration plate 232, and an outer side of the centering spider 233 is connected to the support assembly 21.

In some examples, as shown in FIG. 6, FIG. 25, and FIG. 26, the vibration assembly 23 further includes a dust-proof cover 234.

In some examples, as shown in FIG. 25, there is a frame structure on a side that is of the support assembly 21 and that faces a cavity 110. For example, the first support 211 includes a frame structure.

In some examples, as shown in FIG. 6, the magnetic circuit assembly 22 is located inside the cavity 110. In some other examples, as shown in FIG. 26, the magnetic circuit assembly 22 may alternatively be located outside the cavity 110.

An embodiment of the present disclosure further provides a speaker system. As shown in FIG. 5 to FIG. 8, FIG. 16 to FIG. 20, FIG. 22, and FIG. 23, the speaker system includes a wall 300 and a speaker module 100. A rear cavity 200 is formed (or referred to as included) on a first side of the wall 300, and a volume of the rear cavity 200 is at least 10 times a volume of a cavity 110 of the speaker module 100. The speaker module 100 is located on a second side of the wall 300, and a vent 120 of the speaker module 100 communicates with the rear cavity 200.

The wall 300 may also be referred to as a barrier plate or an installation wall. When the rear cavity 200 on the first side of the wall 300 is infinitely large, the wall 300 may also be referred to as an infinitely large barrier plate.

According to the technical solution provided in this embodiment of the present disclosure, because the rear cavity 200 is large enough, a low-frequency extension capability of the speaker module 100 can be improved by making the vent 120 of the speaker module 100 communicate with the rear cavity 200, to ensure low-frequency performance of the speaker module 100. The speaker module 100 does not need to be excessively large in volume, and does not need to occupy excessively large space.

In addition, within an operating frequency band of the speaker module 100, when a speaker 2 vibrates, a passive vibration plate 3 is driven to vibrate, and sound waves generated by the speaker 2 and the passive vibration plate 3 can be superposed. This increases a sound pressure level of the speaker module 100 on the operating frequency band, and improves sound energy utilization.

In some examples, as shown in FIG. 5 to FIG. 8, FIG. 16 to FIG. 20, FIG. 22, and FIG. 23, the speaker module 100 is installed on the wall 300, the wall 300 is provided with a through hole 400, and the vent 120 communicates with the rear cavity 200 through the through hole 400.

An application scenario of the speaker system is not limited in embodiments of the present disclosure, provided that there is a rear cavity 200 that is large enough (a volume of the rear cavity 200 is at least 10 times the volume of the cavity 110) or a barrier plate (a wall 300) that is large enough in the application scenario. The following describes an example of the application scenario of the speaker system.

In some examples, as shown in FIG. 27 to FIG. 30, the speaker system is used in a vehicle. In this case, the wall 300 is a wall of the vehicle, for example, a bottom wall or a side wall of the vehicle. The vent 120 of the speaker module 100 communicates with the outside of the vehicle, and the outside of the vehicle forms an infinitely large rear cavity 200. For a specific solution in which the speaker system is used in the vehicle, refer to the following vehicle-related content. Details are not described herein again.

In some examples, the speaker system is used in a room, and the wall 300 is a side wall, a bottom wall, or a top wall of the room. In some examples, the speaker module 100 is located inside the room, the vent 120 of the speaker module 100 leads to the outside of the room, and the outside of the room forms an infinitely large rear cavity 200.

In some other examples, the speaker module 100 is located in one room, the vent 120 of the speaker module 100 leads to another room, and a volume of space (a rear cavity 200) inside the other room is at least 10 times the volume of the cavity 110.

An embodiment of the present disclosure further provides a vehicle. As shown in FIG. 27 to FIG. 30, the vehicle includes a speaker module 100, the speaker module 100 is located inside the vehicle, and a vent 120 of the speaker module 100 communicates with the outside of the vehicle.

According to the technical solution provided in this embodiment of the present disclosure, because space outside the vehicle forms an infinitely large rear cavity 200, a low-frequency extension capability of the speaker module 100 is improved by making the vent 120 of the speaker module 100 communicate with the outside of the vehicle, to ensure low-frequency performance of the speaker module 100. The speaker module 100 does not need to be excessively large in volume, and the speaker module 100 does not occupy excessively large space inside the vehicle.

In addition, within an operating frequency band of the speaker module 100, when a speaker 2 vibrates, a passive vibration plate 3 is driven to vibrate, and sound waves generated by the speaker 2 and the passive vibration plate 3 can be superposed. This increases a sound pressure level of the speaker module 100 on the operating frequency band, and improves sound energy utilization.

In some examples, as shown in FIG. 27 to FIG. 30, the speaker module 100 is installed on a wall 300 of the vehicle, the wall 300 of the vehicle is provided with a through hole 400, and the vent 120 of the speaker module 100 communicates with the outside of the vehicle through the through hole 400.

A specific installation position of the speaker module 100 is not limited in embodiments of the present disclosure. In some examples, to reduce occupation of activity space of people inside the vehicle, the speaker module 100 may be installed at the following several positions.

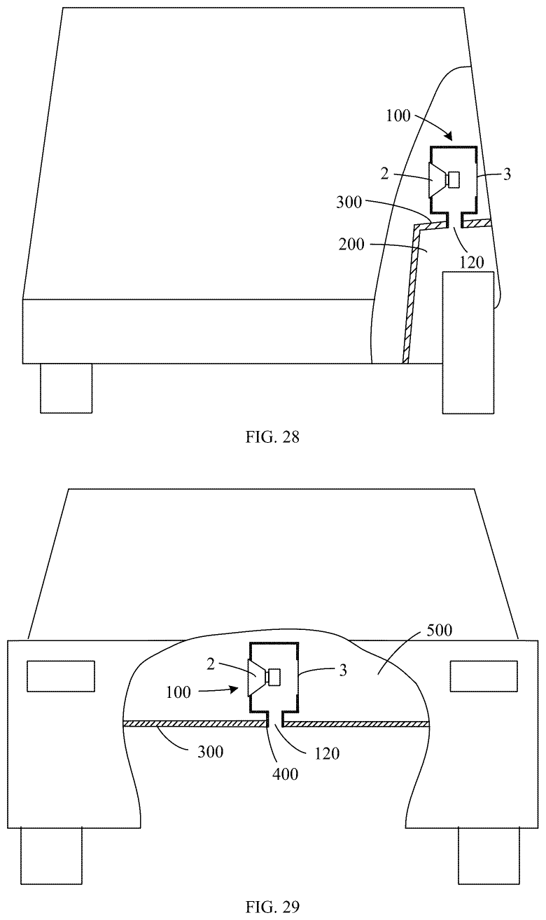

In some examples, as shown in FIG. 28, the speaker module 100 is located above a tire of the vehicle, and the wall 300 is a wall above the tire. In some examples, the vent 120 of the speaker module 100 faces downward, and the speaker 2 and the passive vibration plate 3 may face a horizontal direction or an approximately horizontal direction of the vehicle, for example, may face the left/right of the vehicle (as shown in FIG. 28), or may face the front/rear of the vehicle.

In some examples, as shown in FIG. 29, the speaker module 100 is located in a trunk 500 of the vehicle, and the wall 300 may be a bottom wall of the trunk 500. In some examples, the vent 120 of the speaker module 100 faces downward, and the speaker 2 and the passive vibration plate 3 may face a horizontal direction or an approximately horizontal direction of the vehicle, for example, may face the left/right of the vehicle (as shown in FIG. 29), or may face the front/rear of the vehicle.

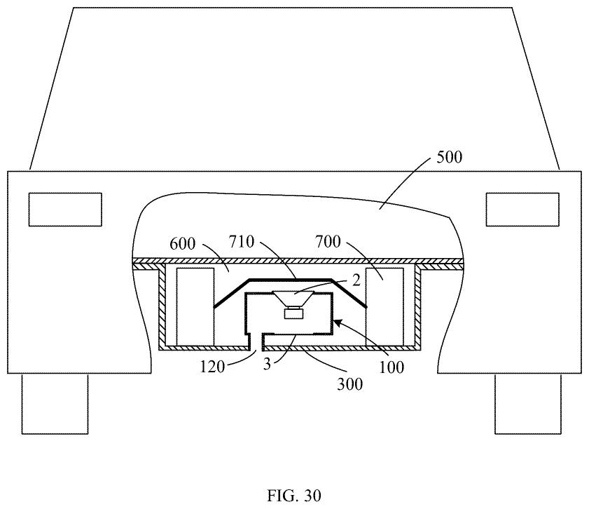

In some examples, as shown in FIG. 30, the speaker module 100 is located in a spare tire accommodation box 600 of the vehicle. The spare tire accommodation box 600 is configured to accommodate a spare tire of the vehicle, and the spare tire accommodation box 600 may be located below the trunk 500 of the vehicle. The wall 300 may be a bottom wall of the spare tire accommodation box 600. In some examples, the vent 120 of the speaker module 100 faces downward, and the speaker 2 and the passive vibration plate 3 may face the top/bottom of the vehicle. For example, the speaker 2 faces the top of the vehicle, and the passive vibration plate 3 faces the bottom of the vehicle.

In addition, a specific position of the speaker module 100 in the spare tire accommodation box 600 is not limited in embodiments of the present disclosure. In some examples, as shown in FIG. 30, the speaker module 100 is located below a hub 710 of a spare tire 700 of the vehicle. The hub 710 includes a frame structure, to facilitate radiating of a sound generated by the speaker module 100 to a cockpit of the vehicle.

In some examples, the speaker module 100 is located in a footwell region of the vehicle. The footwell region is a position used by a driver or a passenger to lay a foot in the cockpit of the vehicle, for example, a footwell region for a driver seat, that is, a region in which a brake and a throttle are located, for another example, a footwell region for a front passenger seat. The wall 300 may be a wall of a chassis of the vehicle. In some examples, the vent 120 of the speaker module 100 faces downward, and the speaker 2 and the passive vibration plate 3 may face a horizontal direction or an approximately horizontal direction of the vehicle, for example, may face the left/right of the vehicle, or may face the front/rear of the vehicle. For example, the speaker 2 faces the rear of the vehicle, and the passive vibration plate 3 faces the front of the vehicle.

Terms used in implementations of the present disclosure are merely used to explain embodiments of the present disclosure, but are not intended to limit the present disclosure. Unless otherwise defined, technical terms or scientific terms used in the implementations of the present disclosure should have a general meaning understood by a person of ordinary skill in the art to which the present disclosure relates. The expressions “first”, “second”, and the like used in the specification and claims of the present disclosure do not indicate any order, quantity, or importance, but are merely used to distinguish between different components. Similarly, the expression “a/an”, “one”, or the like does not indicate a quantity limitation, but indicates at least one. The expression “include”, “comprise”, or the like means that an element or object before “include” or “comprise” encompasses elements or objects and their equivalents listed after “include” or “comprise”, and other elements or objects are not excluded. Expressions such as “above”, “below”, “left”, and “right” are merely used to indicate a relative position relationship. When an absolute position of a described object changes, the relative position relationship may also change accordingly. “A plurality of” means two or more, unless otherwise expressly limited.

The foregoing descriptions are merely optional embodiments of the present disclosure, but are not intended to limit the present disclosure. Any modification, equivalent replacement, improvement, or the like made without departing from the principle of the present disclosure shall fall within the protection scope of the present disclosure.

1. A speaker module, comprising:
a frame body comprising a first opening, a second opening, and a vent;
a speaker located at the first opening and having a first resonant frequency;
a passive vibration plate located at the second opening and having a second resonant frequency greater than the first resonant frequency; and
a cavity formed among the frame body, the speaker, and the passive vibration plate, and configured to communicate with the vent.

2. The speaker module of claim 1, wherein a ratio of the second resonant frequency to an upper limit frequency of an operating frequency band of the speaker module is greater than 0.8.

3. The speaker module of claim 2, wherein the ratio is less than 2.

4. The speaker module of claim 1, further comprising a system comprising the cavity and the passive vibration plate, wherein the second resonant frequency is greater than a third resonant frequency of the system.

5. The speaker module of claim 1, wherein a ratio of the second resonant frequency to the first resonant frequency is greater than 1.5.

6. The speaker module of claim 1, wherein the speaker comprises a vibration assembly having a first mass, and wherein a ratio of a second mass of the passive vibration plate to the first mass is less than 0.5.

7. The speaker module of claim 1, wherein the speaker comprises a vibration plate having a first area, and wherein a ratio of a second area of the passive vibration plate to the first area is greater than 0.5 and less than 2.

8. The speaker module of claim 1, wherein the vent is configured to communicate with a rear cavity, and wherein a ratio of a first volume of the rear cavity to a second volume of the cavity is greater than 10.

9. The speaker module of claim 1, wherein the frame body further comprises:
comprising:
a first end in communication with the cavity; and
a second end comprising the vent; and
a main portion comprising the first opening and the second opening, and wherein the cavity is formed among the main portion, the speaker, and the passive vibration plate.

10. The speaker module of claim 9, wherein a ratio of a third resonant frequency of the cavity and the pipe to the second resonant frequency is greater than 0.5.

11. The speaker module of claim 9, wherein the main portion further comprises:
a side coupled to the pipe;
a third end comprising the first opening; and
a fourth end comprising the second opening.

12. The speaker module of claim 1, wherein the speaker closes the first opening, and wherein the passive vibration plate closes the second opening.

13. The speaker module of claim 1, wherein the speaker is opposite to the passive vibration plate.

14. The speaker module of claim 1, wherein the frame body comprises two first openings located opposite to each other, wherein the speaker comprises a first speaker and a second speaker abutting against the first speaker, and wherein the first speaker and the second speaker are located at the two first openings, respectively.

15. The speaker module of claim 14, wherein the frame body comprises two second openings, wherein the passive vibration plate comprises a first passive vibration plate and a second passive vibration plate, wherein the first passive vibration plate and the second passive vibration plate are located at the two second openings respectively, wherein a second cavity is formed among the first speaker, the first passive vibration plate, and the frame body, wherein a third cavity is formed among the second speaker, the second passive vibration plate, and the frame body, and wherein the second cavity and the third cavity communicate with the vent.

16. The speaker module of claim 1, further comprising a protective cover coupled to the frame body and covering the passive vibration plate.

17. The speaker module of claim 1, wherein the speaker comprises:
a support assembly;
a vibration assembly, comprising:
a voice coil;
a vibration plate coupled to the voice coil and the support assembly; and
a centering spider coupled to the vibration plate and the support assembly; and
a magnetic circuit assembly configured to drive the voice coil to vibrate, wherein the support assembly supports the magnetic circuit assembly and the vibration assembly.

18. The speaker module of claim 17, wherein the support assembly comprises a side that has a frame structure and that faces the cavity.

19. A speaker system, comprising:
a wall comprising a first side and a second side;
a rear cavity located on the first side; and
a speaker module located on the second side and comprising:
a frame body comprising:
a first opening;
a second opening; and
a vent configured to communicate with the rear cavity;
a speaker located at the first opening and having a first resonant frequency;
a passive vibration plate located at the second opening and having a second resonant frequency greater than the first resonant frequency; and
a cavity formed among the frame body, the speaker, and the passive vibration plate and configured to communicate with the vent,
wherein a ratio of a first volume of the rear cavity to a second volume of the cavity is greater than 10.

20. A vehicle, comprising:
a speaker module comprising:
a frame body comprising:
a first opening;
a second opening; and
a vent configured to communicate with an exterior of the vehicle;
a speaker located at the first opening and having a first resonant frequency;
a passive vibration plate located at the second opening and having a second resonant frequency greater than the first resonant frequency; and
a cavity formed among the frame body, the speaker, and the passive vibration plate and configured to communicate with the vent.
